(19) United States
(12) Patent Application Publication
(10) Pub. No.: US 2023/0108198 A1
(43) Pub. Date: Apr. 6, 2023

(54) ABNORMAL ACCESS PREDICTION SYSTEM, ABNORMAL ACCESS PREDICTION METHOD, AND PROGRAMRECORDING MEDIUM

(71) Applicant: NEC Corporation, Minato-ku, Tokyo (JP)

(72) Inventor: Ryosuke TOGAWA, Tokyo (JP)

(73) Assignee: NEC Corporatiom, Minato-ku, Tokyo (JP)

(21) Appl. No.: 17/907,759

(22) PCT Filed: Mar. 27, 2020
(86) PCT No.: PCT/JP2020/013888

§ 371 Date: Aug. 29, 2022

(51) Int. Cl. H04L 41/0631; H04L 41/0604; H04L 43/045

(52) U.S. Cl. CPC H04L 41/064; H04L 41/0627; H04L 43/045

(57) ABSTRACT

An abnormal access prediction system is configured to comprise an acquisition unit and a prediction unit. The acquisition unit acquires time-series access data and time-series resource usage data in a first period. The time-series access data is data relating to access to a server on a network from a first plurality of terminal devices individually operated by a first plurality of users. The time-series resource usage data is data relating to a time-series change in resource usage of each of the first plurality of terminal devices. The prediction unit predicts a terminal device that performs abnormal access by using: a prediction model generated on the basis of time-series access data and time-series resource usage data in a second period earlier than the first period; time-series access data in the first period; and time-series resource usage data.

### TECHNICAL FIELD

The present invention relates to a network monitoring technique, and more particularly, to a technique of predicting a terminal device that is performing access different from normal access.

### BACKGROUND ART

In order to maintain network security such as prevention of confidential information leakage, it is important to prevent abnormal access such as illegal access to a server on a network from an unauthorized terminal device. Abnormal access is performed in a plurality of steps such as via a plurality of terminal devices in some cases, and a huge amount of work can be required to detect abnormal access on the basis of individual access records. Thus, techniques of automatically monitoring a network to prevent abnormal access have been actively developed. As such a network monitoring technique for preventing abnormal access, for example, techniques as in PTL 1, PTL 2, and PTL 3 are disclosed.

PTL 1 discloses a technique of analyzing a log of processing executed in a server or the like as time-series data and detecting illegal access. PTL 2 and PTL 3 disclose a technique of detecting network abnormalities.

### CITATION LIST

### Patent Literature

PTL 1 JP 2018-61240 A
PTL 2 JP 2019-80201 A
PTL 3 JP 2014-123996 A

### SUMMARY OF INVENTION

### Technical Problem

Unfortunately, the techniques of PTL 1, PTL 2, and PTL 3 cannot detect a terminal device that is performing illegal access to a network by tracing a plurality of steps. Thus, in the techniques of PTL 1, PTL 2, and PTL 3, there is a possibility that illegal access cannot be detected as abnormal access in a case, for example, where the illegal access is performed via another terminal device.

In order to solve the above problems, it is an object of the present invention to provide an abnormal access analysis system and the like that can improve network security and enhance management efficiency by presenting, by prediction, a candidate of a terminal device that has performed abnormal access even when the abnormal access is performed in a plurality of access steps.

### Solution to Problem

In order to solve the above problems, an abnormal access prediction system of the present invention includes an acquisition unit and a prediction unit. The acquisition unit acquires time-series access data and time-series resource usage data in a first period. The time-series access data is data relating to access to a server on a network from a first plurality of terminal devices individually operated by a first plurality of users. The time-series resource usage data is data relating to a time-series change in resource usage of each of the first plurality of terminal devices. The prediction unit predicts a terminal device that performs abnormal access among the first plurality of terminal devices by using a prediction model generated on the basis of time-series access data and time-series resource usage data in a second period earlier than the first period, and the time-series access data and the time-series resource usage data in the first period. The time-series access data in the second period is data relating to access when the server on the network is accessed from a second plurality of terminal devices individually operated by a second plurality of users in the second period. The time-series resource usage data in the second period is data relating to a time-series change in resource usage of each of the second plurality of terminal devices in the second period.

An abnormal access prediction method of the present invention acquires time-series access data and time-series resource usage data in a first period. The time-series access data is data relating to access to a server on a network from a first plurality of terminal devices individually operated by a first plurality of users. The time-series resource usage data is data relating to a time-series change in resource usage of each of the first plurality of terminal devices. The abnormal access prediction method of the present invention predicts a terminal device that performs abnormal access among the first plurality of terminal devices by using a prediction model generated on the basis of time-series access data and time-series resource usage data in a second period earlier than the first period, and the time-series access data and the time-series resource usage data in the first period. The time-series access data in the second period is data relating to access when the server on the network is accessed from a second plurality of terminal devices individually operated by a second plurality of users in the second period. The time-series resource usage data in the second period is data relating to a time-series change in resource usage of each of the second plurality of terminal devices in the second period.

In a program recording medium of the present invention, an abnormal access prediction program is recorded. The abnormal access prediction program causes a computer to execute a process of acquiring time-series access data and time-series resource usage data in a first period. The time-series access data is data relating to access to a server on a network from a first plurality of terminal devices individually operated by a first plurality of users. The time-series resource usage data is data relating to a time-series change in resource usage of each of the first plurality of terminal devices. The abnormal access prediction program of the present invention causes a computer to execute a process of predicting a terminal device that performs abnormal access among the first plurality of terminal devices by using a prediction model generated on the basis of time-series access data and time-series resource usage data in a second period earlier than the first period, and the time-series access data and the time-series resource usage data in the first period. The time-series access data in the second period is data relating to access when the server on the network is accessed from a second plurality of terminal devices individually operated by a second plurality of users in the second period. The time-series resource usage data in the second period is data relating to a time-series change in resource usage of each of the second plurality of terminal devices in the second period.

### Advantageous Effects of Invention

The present invention can suitably support network management such as improvement of network security and enhancement of management efficiency by predicting a candidate of a terminal device that is performing abnormal access in a plurality of steps.

### BRIEF DESCRIPTION OF DRAWINGS

FIG. 1 is a diagram illustrating a configuration of an abnormal access prediction system according to a first example embodiment of the present invention.

FIG. 2 is a diagram illustrating a configuration of a prediction model generation device according to the first example embodiment of the present invention.

FIG. 3 is a diagram schematically illustrating an example of a graph according to the first example embodiment of the present invention.

FIG. 4 is a diagram illustrating a configuration of a prediction device according to the first example embodiment of the present invention.

FIG. 5 is a diagram illustrating an operation flow of the prediction model generation device according to the first example embodiment of the present invention.

FIG. 6 is a diagram illustrating an example of input data according to the first example embodiment of the present invention.

FIG. 7 is a diagram illustrating an example of input data according to the first example embodiment of the present invention.

FIG. 8 is a diagram illustrating an example of input data according to the first example embodiment of the present invention.

FIG. 9 is a diagram illustrating an operation flow of the prediction device according to the first example embodiment of the present invention.

FIG. 10 is a diagram illustrating an example of a prediction result according to the first example embodiment of the present invention.

FIG. 11 is a diagram illustrating a configuration of an abnormal access prediction system according to a second example embodiment of the present invention.

FIG. 12 is a diagram illustrating an operation flow of the abnormal access prediction system according to the second example embodiment of the present invention.

FIG. 13 is a diagram illustrating an example of another configuration of the present invention.

### EXAMPLE EMBODIMENTS

### First Example Embodiment

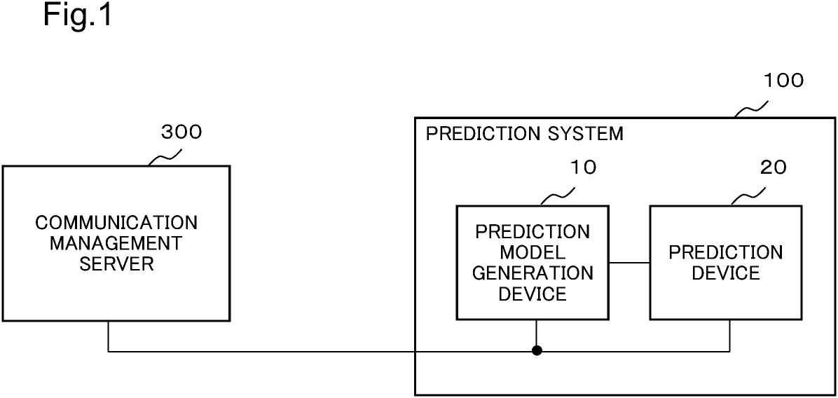

A first example embodiment of the present invention will be described in detail with reference to the drawings. FIG. 1 is a diagram illustrating a configuration outline of an abnormal access prediction system according to the present example embodiment. The abnormal access prediction system of the present example embodiment includes a prediction system 100 and a communication management server 300. The prediction system 100 and the communication management server 300 are connected via a network.

The abnormal access prediction system of the present example embodiment is a system that predicts a terminal device that is performing abnormal access by using a prediction model from a time-series access history to a server or the like on a network from each of a plurality of terminal devices and a resource usage of each of the terminal devices. The abnormal access prediction system of the present example embodiment is particularly characterized by predicting a terminal device that is performing abnormal access over a plurality of steps.

For example, when a period in which the terminal device that is performing abnormal access is to be predicted is a first period, the prediction model is generated by using the time-series access histories to the server or the like from the terminal devices and the resource usage of each of the terminal devices in a second period earlier than the first period. Suppose that the terminal device that is performing abnormal access is predicted from among a first plurality of terminal devices individually operated by a first plurality of users in the first period, by using the prediction model. At this time, the prediction model is generated by using a time-series access history to the server or the like on the network from each of a second plurality of terminal devices individually operated by a second plurality of users and a resource usage of each of the terminal devices in the second period. The first plurality of terminal devices and the second plurality of terminal devices may be the same or different. Some of the first plurality of terminal devices and some of the second plurality of terminal devices may be the same. Similarly, the first plurality of users and the second plurality of users may be the same or different. Some of the first plurality of users and some of the second plurality of users may be the same.

The abnormal access refers to access that illegally uses a network, such as unauthorized illegal data acquisition, illegal data browsing, falsification of data, erasure of data, unauthorized access, and unauthorized resource use. The abnormal access also includes an action of intentionally increasing network load. The abnormal access further includes access not intended by a user who operates the terminal device, such as the above operations by a computer virus.

The abnormal access over a plurality of steps means, for example, that a certain terminal device illegally accesses a server or the like on a network to which the terminal device is not authorized to connect, via a plurality of other terminal devices. The abnormal access over a plurality of steps also means that a user who performs illegal access uses a certain account or authentication information and then uses an account or authentication information of another unauthorized user to illegally access a server or the like on a network. The abnormal access over a plurality of steps further includes access to perform illegal data acquisition or the like by accessing a server from one terminal device a plurality of times.

The prediction system 100 includes a prediction model generation device 10 and a prediction device 20. The prediction model generation device 10 and the prediction device 20 are connected via the network. The prediction model generation device 10 and the prediction device 20 may also be formed as an integrated device.

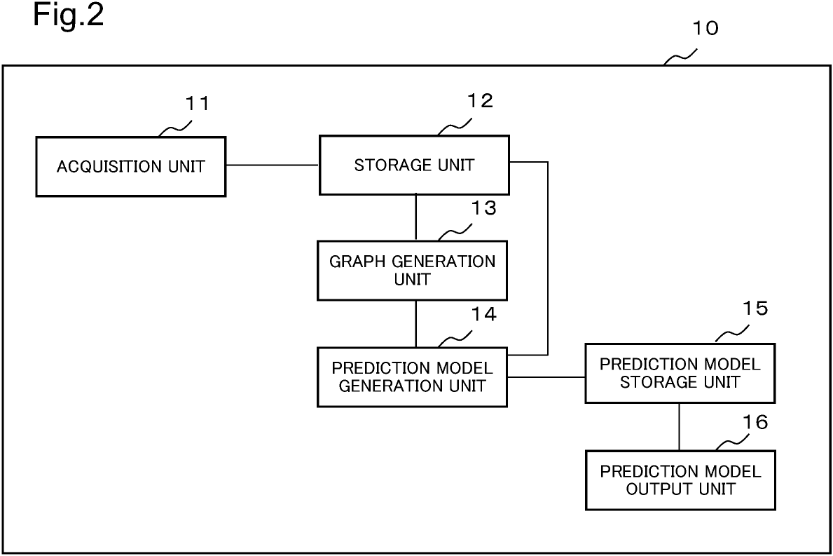

A configuration of the prediction model generation device 10 will be described. FIG. 2 is a diagram illustrating the configuration of the prediction model generation device 10. The prediction model generation device 10 includes an acquisition unit 11, a storage unit 12, a graph generation unit 13, a prediction model generation unit 14, a prediction model storage unit 15, and a prediction model output unit 16. The prediction model generation device 10 is a device that generates the prediction model used when predicting the terminal device that is performing abnormal access from a time-series access history to the server or the like on the network from each of a plurality of terminal devices and a resource usage of each of the terminal devices. The plurality of terminal devices are individually operated by users. The same user may operate two or more of the terminal devices.

The acquisition unit 11 acquires data used for generating the prediction model. The acquisition unit 11 acquires, as time-series access data, data indicating the time-series access histories to another terminal device and the server on the network from the plurality of terminal devices individually operated by the plurality of users.

As the time-series access data, for example, an event log that is a log of processing in the server is used. The event log is time-series data including a terminal device that has requested the server to perform processing and the processing executed by the server in response to the request. Communication history data may be used as the time-series access data. The communication history data is time-series data including information of a connection source and a connection destination. The time-series access data may be data other than the event log and the communication history as long as the history of communication between the terminal devices and between the terminal devices and the server is indicated in time series.

The acquisition unit 11 also acquires data of the time-series resource usage of each of the plurality of terminal devices as time-series resource usage data. As the time-series resource usage data, for example, time transition data on the amount of data read from the server by each terminal device is used. Any other data may be used as the time-series resource usage data as long as the data is time-series data relating to the resource usage of the network or the server, such as the number of accesses to the server from each terminal device, and a network band being used.

The acquisition unit 11 acquires the time-series access data and the time-series resource usage data from the communication management server 300. The time-series access data and the time-series resource usage data may be input to the prediction model generation device 10 by an operator. The acquisition unit 11 may also acquire the time-series access data and the time-series resource usage data in a prediction-target period from each terminal device and the server.

The storage unit 12 stores the time-series access data and the time-series resource usage data input from the acquisition unit 11.

The graph generation unit 13 generates a graph as graph structure data from the time-series access data. The graph structure data generated from the time-series access data includes nodes indicating the terminal devices and the server included in the time-series access data, and edges indicating that access exists between the terminal devices and between the terminal devices and the server.

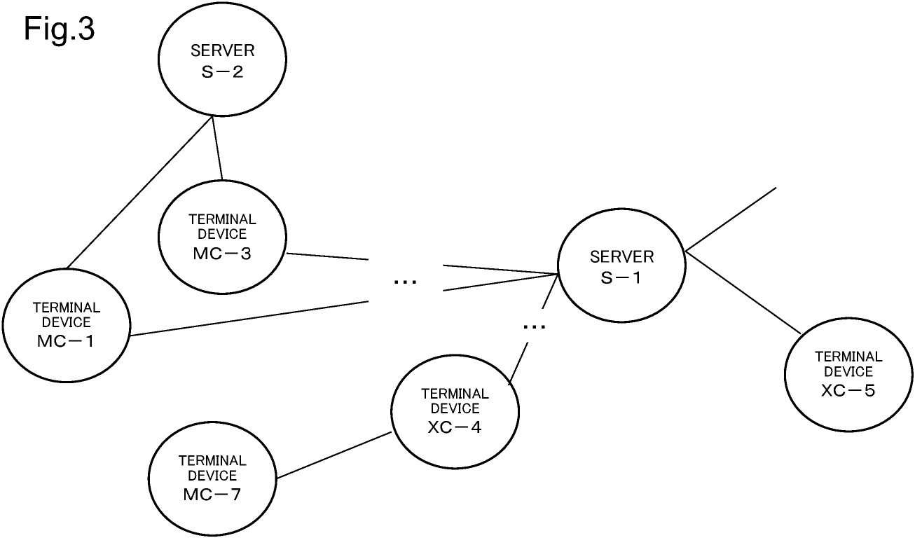

FIG. 3 schematically illustrates an example of the graph generated by the graph generation unit 13. Circles in FIG. 3 are nodes each indicating a terminal device or a server. In FIG. 3, identification information of the terminal devices and the servers is schematically illustrated in the circles. The identification information may be in any format that can identify the individual devices, such as a device name or an address. A line (also referred to as an edge) connecting the nodes indicates that there has been access between the terminal devices or between the terminal devices and the server connected by the line. That is, the edge between the nodes indicates that there is access (communication) between the terminal devices or the servers indicated by the nodes.

The prediction model generation unit 14 generates the prediction model for predicting the terminal device that is performing abnormal access. The prediction model generation unit 14 generates the prediction model for predicting the terminal device that is performing abnormal access on the basis of the graph structure data and the time-series resource usage data. The prediction model generation unit 14 generates the prediction model by taking the graph structure data and the time-series resource usage data as input, and computing feature values of the graph by machine learning using a neural network (NN) or deep learning. The prediction model may also be generated using any machine learning method, such as supervised learning, unsupervised learning, semi-supervised learning, or reinforcement learning. For example, in the case of supervised learning, the prediction model generation unit 14 generates the prediction model on the basis of the graph structure data and the time-series resource usage data by using labeled data indicating whether the terminal device predicted to perform abnormal access has actually performed abnormal access.

The prediction model generation unit 14 generates the prediction model by computing the feature values of the graph by the STAR method, for example. In the STAR method, the prediction model is generated by taking the graph structure data at a plurality of points in time as input and computing the feature values of the graph. Details of the STAR method are described in Dongkuan Xu et al., “Spatio-Temporal Attentive RNN for Node Classification in Temporal Attributed Graphs”, Proceedings of the Twenty-Eighth International Joint Conference on Artificial Intelligence (IJCAI-19), [Retrieved Feb. 27, 2020] Internet <URL: https://www.ijcai.org/Proceedings/2019/0548.pdf>.

Alternatively, the prediction model generation unit 14 may generate the prediction model by computing the feature values of the graph using the TGNet method. The TGNet method performs machine learning by taking dynamic data, static data, and labeled data as input, and generates a learned model. Details of the TGNet method are described in Qi Song, et al., “TGNet: Learning to Rank Nodes in Temporal Graphs”, Proceedings of the 27th ACM International Conference on Information and Knowledge Management, pp. 97-106.

The prediction model generation unit 14 may also generate the prediction model by extracting the feature values using a feature value extraction method such as the Netwalk method, in combination with a method of analyzing the feature values such as the InerHAT method. Details of the Netwalk method are described in Wenchow Yu, et al., “NetWalk: A Flexible Deep Embedding Approach for Anomaly Detection in Dynamic Networks”, KDD 2018, pp. 2672-2681. Details of the InerHAT method are described in Zeyu Li, et al., “Interpretable Click-Through Rate Prediction through Hierarchical Attention”, WSDM 2020: The Thirteenth ACM International Conference on Web Search and Data Mining. Instead of the InerHAT method, a prediction technique such as Gradient Boosting method may also be used. The prediction model generation unit 14 may generate the prediction model using any other method that analyzes the graph and extracts a feature pattern.

The prediction model storage unit 15 stores the prediction model generated by the prediction model generation unit 14.

The prediction model output unit 16 outputs the prediction model stored in the prediction model storage unit 15 to the prediction device 20.

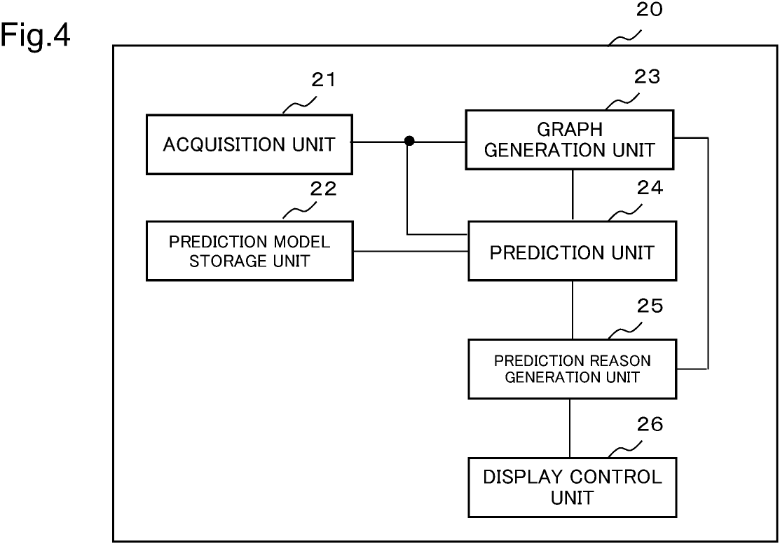

A configuration of the prediction device 20 will be described. FIG. 4 is a diagram illustrating the configuration of the prediction device 20. The prediction device 20 includes an acquisition unit 21, a prediction model storage unit 22, a graph generation unit 23, a prediction unit 24, a prediction reason generation unit 25, and a display control unit 26.

The acquisition unit 21 acquires input data used when predicting the terminal device that is performing abnormal access by using the prediction model. The acquisition unit 21 acquires time-series access data indicating a time-series access history to the network from each of a plurality of terminal devices, and time-series resource usage data indicating a time-series resource use history of each of the terminal devices in a prediction-target period. The acquisition unit 21 acquires the time-series access data and the time-series resource usage data in the prediction-target period from the communication management server 300. The time-series access data and the time-series resource usage data in the prediction-target period may be input to the prediction device 20 by an operator. The acquisition unit 21 may acquire the time-series access data and the time-series resource usage data in the prediction-target period from each terminal device and the server.

The prediction model storage unit 22 stores the prediction model generated by the prediction model generation device 10. The prediction model stored in the prediction model storage unit 22 is input from the prediction model generation device 10. The acquisition unit 21 may acquire the prediction model from the prediction model generation device 10.

The graph generation unit 23 generates graph structure data from the time-series access data in the prediction-target period. The graph structure data generated from the time-series access data includes nodes indicating the terminal devices and the server, and edges indicating an access sequence or the presence or absence of communication access between the terminal devices or between the terminal devices and the server. That is, the graph generated by the graph generation unit 23 is a graph regarding the access sequence or the presence or absence of communication access between the terminal devices or between the terminal devices and the server. The edge may include information of both the access sequence and the presence or absence of communication access between the terminal devices or between the terminal devices and the server.

The prediction unit 24 predicts the terminal device that is performing abnormal access from the input data by using the prediction model stored in the prediction model storage unit 22. The prediction unit 24 predicts the terminal device that is performing abnormal access using the prediction model by taking the graph structure data based on the time-series access data, and the time-series resource usage data in the prediction-target period as input.

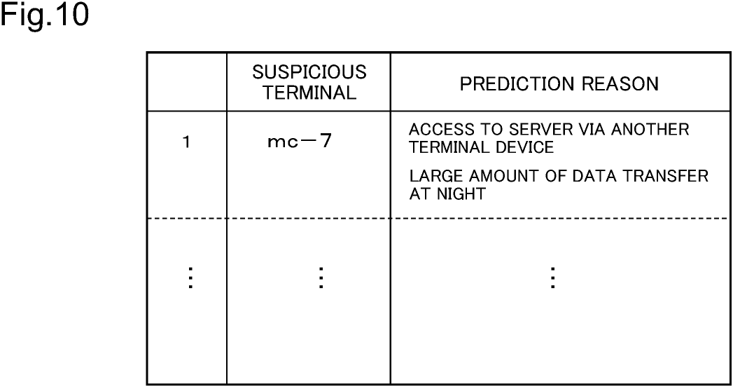

The prediction reason generation unit 25 generates a prediction reason why the prediction unit 24 predicts the terminal device that is performing abnormal access. The prediction reason will be described in a prediction phase described later with reference to FIG. 10.

The display control unit 26 controls a display unit (not illustrated) included in the prediction device 20 or a display device provided outside the prediction device 20 to display a prediction result to which the prediction reason is added. The display control unit 26 may also control the display on the display device by transmitting the prediction result to which the prediction reason is added to a terminal of a user who uses the prediction result, but the display control method is not limited to this. The display control unit 26 may control the display device to display only the prediction result on the display device. As a result, the abnormal access prediction system of the present example embodiment can more suitably support management of network security by presenting the terminal device that possibly performs abnormal access and the reason for predicting the terminal device that possibly performs abnormal access to an administrator of the network.

Each processing in the acquisition unit 21, the graph generation unit 23, the prediction unit 24, the prediction reason generation unit 25, and the display control unit 26 is performed by executing a computer program on a CPU.

The prediction model storage unit 22 is configured using, for example, a hard disk drive. The prediction model storage unit 22 may be configured by a nonvolatile semiconductor storage device or a combination of a plurality of types of storage devices.

In FIG. 1, the communication management server 300 acquires and stores communication history data on the network and an event log of the server. The communication management server 300 acquires communication history data between the terminal devices and between the terminal devices and the server from each terminal device and the server, or a communication device on the network. The communication management server 300 stores the acquired communication history data and the acquired event log data as the time-series access data. The communication management server 300 also transmits the time-series access data and the time-series resource usage data to each of the prediction model generation device 10 and the prediction device 20.

### Learning Phase

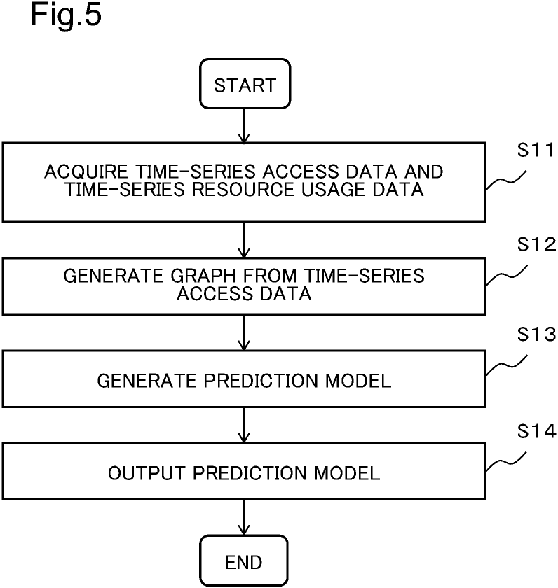

An operation of the abnormal access prediction system of the present example embodiment will be described. First, an operation for generating the prediction model used for predicting the terminal device that is performing abnormal access will be described. FIG. 5 is a diagram illustrating an operation flow when the prediction model generation device 10 generates the prediction model for predicting the terminal device that is performing abnormal access.

The acquisition unit 11 acquires the time-series access data indicating the time-series access histories to the server from the plurality of terminal devices individually operated by the plurality of users, and the time-series resource usage data by the access of each of the terminal devices (step S11). The acquisition unit 11 acquires each data from the communication management server 300. After acquiring each data, the acquisition unit 11 stores the acquired data in the storage unit 12.

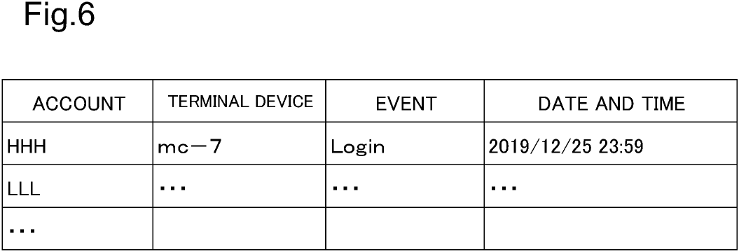

FIG. 6 is a diagram illustrating an example of the time-series access data. The example of the time-series access data in FIG. 6 illustrates the event log of the server. In the event log of the server in FIG. 6, information of an account of a user who operates the terminal device, identification information of the terminal device, an event, and access date and time are associated with each other. The event in FIG. 6 indicates the content of a processing request to the server.

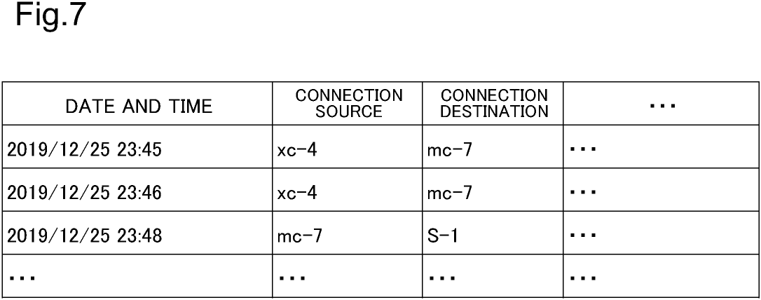

FIG. 7 illustrates the communication history data that is an example of the time-series access data. In the example of the communication history data in FIG. 7, information of date and time when access is performed between the devices, identification information of the terminal device or the server as a connection source, and information of the terminal device as a connection destination are associated with each other. The communication history data may be associated with the content of communication processing such as connection.

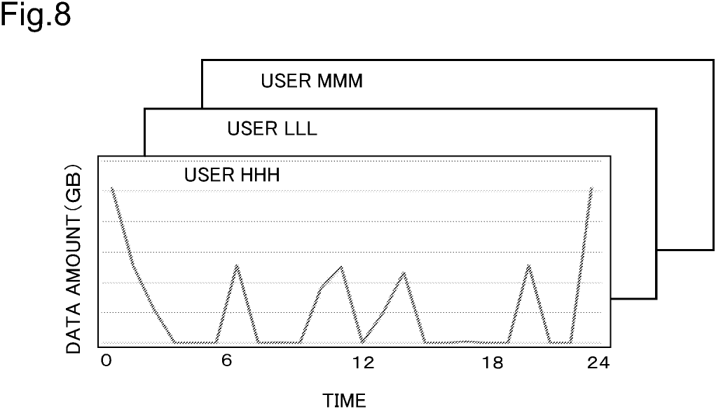

FIG. 8 is a diagram illustrating an example of the time-series resource usage data. FIG. 8 illustrates time transition of the resource usage for each terminal device operated by each user. In FIG. 8, the horizontal axis represents time and the vertical axis represents the amount of data. In the example of FIG. 8, the vertical axis is indicated in units of giga byte (GB), but may be indicated in another unit. The resource usage is set as, for example, a data read amount from the server. The resource usage may be normalized by a maximum value or another value.

When the time-series access data is acquired, the graph generation unit 13 generates the graph structure data on the basis of the time-series access data (step S12). The graph generation unit 13 generates the graph structure data including the nodes indicating the terminal devices and the server and the edges indicating that there has been access between the nodes on the basis of the time-series access data. After generating the graph structure data, the graph generation unit 13 transmits the generated graph structure data to the prediction model generation unit 14. The graph generation unit 13 may also generate the graph structure data in which the users who use the terminal devices are defined as the nodes instead of the terminal devices, and access to the server by any user is defined as the edge.

When the graph structure data is input, the prediction model generation unit 14 reads each data used for generating the prediction model from the storage unit 12. After reading each data, the prediction model generation unit 14 generates the prediction model for predicting the terminal device that is performing abnormal access by taking the graph structure data and the time-series resource usage data as input and performing machine learning (step S13).

After generating the prediction model, the prediction model generation unit 14 stores the generated prediction model as a learned model in the prediction model storage unit 15. When the prediction model is generated, the prediction model output unit 16 outputs the prediction model to the prediction device 20 (step S14). The prediction model input to the prediction device 20 is stored in the prediction model storage unit 22.

The prediction model generated by the prediction model generation device 10 may be updated by relearning. For example, the prediction model generation unit 14 performs relearning using the time-series access data indicating the access to the server from the terminal devices by the plurality of users and the resource usage data by the access of each user in the period in which the prediction is performed using the prediction model. Performing the relearning enables further improvement of prediction accuracy of predicting a candidate of the terminal device that is performing abnormal access in the network as a prediction target. The prediction model generation unit 14 may also generate a new prediction model using, as labeled data, whether the terminal device predicted to perform abnormal access has actually performed abnormal access by taking the time-series access data and the resource usage as input.

### Prediction Phase

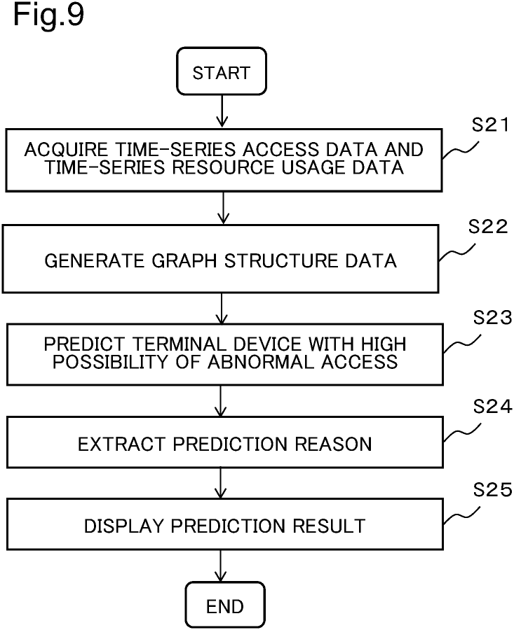

Next, an operation for predicting the terminal device that is performing abnormal access in the prediction device 20 will be described. FIG. 9 is a diagram illustrating an operation flow when the prediction device 20 predicts the terminal device that is performing abnormal access by using the prediction model.

The acquisition unit 21 acquires the time-series access data and the time-series resource usage data relating to the access to the server from the individual terminal devices, performed in the prediction-target period (step S21). When the acquisition unit 21 acquires the time-series access data and the time-series resource usage data, the graph generation unit 23 generates the graph structure data from the time-series access data (step S22). After generating the graph structure data, the graph generation unit 23 transmits the graph structure data of the time-series access data to the prediction unit 24.

After receiving the graph structure data, the prediction unit 24 predicts the terminal device that is performing abnormal access by using the prediction model stored in the prediction model storage unit 22 and taking the graph structure data of the time-series access data and the time-series resource usage data as input (step S23). After predicting the terminal device that is performing abnormal access, the prediction unit 24 transmits identification information of the terminal device that is performing abnormal access to the prediction reason generation unit 25. The prediction unit 24 predicts a terminal device having a low degree of similarity with access tendencies of other terminal devices as the terminal device that is performing abnormal access. The prediction unit 24 may also predict a terminal device having a low degree of similarity with a past access tendency as the terminal device that is performing abnormal access. The prediction unit 24 may further predict the terminal device that is performing abnormal access on the basis of a time-series feature such as a time-series sequence of access to the server or another terminal device.

After receiving the prediction result, the prediction reason generation unit 25 extracts the prediction reason (step S24). The prediction reason is information for presenting the prediction reason by the prediction unit 24 to the user. For example, the prediction reason generation unit 25 extracts an edge having a high degree of contribution to the prediction of abnormal access, that is, dissimilarity to the access tendencies of other terminal devices, and generates the prediction reason on the basis of access performed between nodes at opposite ends of the extracted edge. Alternatively, the prediction reason generation unit 25 may extract a terminal device having a current access tendency different from the past access tendency of the same terminal device, and generate the prediction reason on the basis of abnormal access performed in this terminal device. For example, in this case, the prediction reason generation unit 25 may generate the prediction reason such as “the current access tendency differs from the past access tendency of the same terminal device” as text data or audio data. The prediction reason generation unit 25 may also generate, as the prediction reason of the terminal device predicted on the basis of the time-series feature, the prediction reason such as “the time-series sequence of access” as text data or audio data.

After generating the prediction reason, the prediction reason generation unit 25 outputs the prediction reason to the display control unit 26.

After receiving the prediction result and the prediction reason, the display control unit 26 controls the display device to display the prediction result and the prediction reason on the display device (step S25). The display control unit 26 may control data transmission of the prediction result and the prediction reason to the terminal of the user so that the prediction result and the prediction reason are displayed on a display device of the terminal of the user who uses the prediction result.

FIG. 10 is a diagram illustrating an example of the display data of the prediction result. In FIG. 10, the identification information of the terminal device predicted to perform abnormal access is illustrated as a suspicious terminal. The prediction reason is presented in association with the identification information of the suspicious terminal that is the prediction result.

In the example of FIG. 10, regarding a suspicious terminal “mc-7”, the prediction reason that the server is accessed via another terminal device and the prediction reason that the amount of data transfer is large at night are illustrated. For example, suppose that a terminal device “xc-4” accesses the server, and the terminal device “mc-7” further accesses the terminal device “xc-4”. At this time, if an edge indicated by the access between the terminal device “mc-7” and the terminal device “xc-4” has a high degree of contribution to the prediction that access patterns of the terminal devices are not similar, the prediction reason generation unit 25 uses the access existing between the terminal device “mc-7” and the terminal device “xc-4” as the prediction reason for predicting the terminal device that is performing abnormal access. The prediction unit 24 and the prediction reason generation unit 25 hold in advance a criterion as to which of the two terminal devices is determined as the suspicious terminal. For example, the prediction unit 24 determines the side accessing the server via another terminal device as the suspicious terminal. The prediction reason that “the amount of data transfer is large at night” in FIG. 10 is extracted by the degree of contribution of the resource usage to the prediction result. The prediction reason that “the amount of data transfer is large at night” in FIG. 10 may be extracted on the basis of attribute data indicating that the amount of data transfer is large at night by deriving the attribute data in advance in preprocessing before the prediction. In such a case, when the terminal device “mc-7” is predicted as the suspicious terminal, the prediction reason generation unit 25 generates the prediction reason from the data transfer amount for each time that is the attribute data of the terminal device “mc-7”. The attribute data regarding the data transfer amount may also be data obtained by extracting the data transfer amount for each time zone, such as “daytime: 9:00 - 17:00”, “nighttime: 18:00 - 21:00”, “midnight: 22:00 -5:00”, and “early morning: 5:00 - 9:00” in advance for each terminal device.

The display control unit 26 may also display the graph regarding the communication access of the terminal devices/server, generated by the graph generation unit 23, instead of the format as illustrated in FIG. 10. In this case, the display control unit 26 may highlight the terminal device predicted to have performed abnormal access in the graph. For example, in the graph, the display control unit 26 may highlight the terminal device predicted to have performed abnormal access by displaying the terminal device so as to enclose the terminal device by a rectangle or a circle, displaying the terminal device in a different color (with a color added), or changing an icon or a node size of the predicted terminal device. By highlighting the terminal device predicted to have performed abnormal access, it is possible to improve the noticeability of the user. By presenting the prediction result and the prediction reason as described above, an administrator of a communication system can recognize the terminal device that is possibly performing abnormal access together with the prediction reason and address the abnormal access.

Attribute data may be set in each of the terminal devices and the server, and may be used for the generation of the prediction model and the prediction using the prediction model. As the attribute data, for example, one or more items of an installation location of the terminal device, a network to which the terminal device is connected, a security measure level of the terminal device, software used, and an intended use of the server can be used. Attribute data of the users who operate the terminal devices may also be used for the generation of the prediction model and the prediction using the prediction model. As the attribute data of the users, for example, one or more items of a user’s affiliation, position, access authority, and information technology skill level can be used.

When the prediction model is generated and the prediction is performed using such attribute data, the prediction reason may be generated on the basis of each attribute data. In such a case, any one or a plurality of items out of the installation location of the terminal device, the network to which the terminal device is connected, the user who operates the terminal device, the security measure level of the terminal device, a communication amount, the number of communications, a communication band, a data transfer amount, the number of data erasures or changes, the number of error occurrences, and the number of login failures may be set as the prediction reason.

When the glass of the time-series access data is generated, the presence or absence of access between the terminal devices or between the terminal devices and the server is indicated as the edge. The edge may also include information such as a communication amount, the number of communications, or a communication frequency. Such a configuration allows for prediction in consideration of an access amount or an access frequency, thereby improving the prediction accuracy of abnormal access.

The time-series access data may be data indicating a time-series sequence of processing performed by each terminal device, in processing performed by the plurality of terminal devices individually accessing the server. Use of the time-series access data indicating the time-series sequence of processing for each terminal device makes it possible to predict a terminal device that executes processing in a sequence different from a normal tendency, thereby predicting the terminal device that is performing abnormal access even when the server is accessed without passing through another terminal device.

In the abnormal access prediction system of the present example embodiment, the prediction model generation device 10 generates the graph structure data on the basis of the time-series access data, and generates the prediction model using the graph structure data and the time-series resource usage data. In the abnormal access prediction system of the present example embodiment, the prediction device 20 predicts the terminal device that is performing abnormal access from the time-series access data and the time-series resource usage data on the basis of the generated prediction model. The abnormal access prediction system of the present example embodiment can predict the terminal device that is performing abnormal access based on access over a plurality of steps by performing the prediction using the prediction model generated on the basis of the graph structure data.

By predicting the terminal device that is performing abnormal access based on access over a plurality of steps, the abnormal access prediction system of the present example embodiment can improve the prediction accuracy of the terminal device that is performing abnormal access. The abnormal access prediction system of the present example embodiment presents the prediction reason together with the prediction result, so that the administrator of the network can set the checking priority by referring to the prediction reason when checking the presence or absence of abnormal access.

For example, when the prediction result as illustrated in FIG. 10 is presented, the administrator of the network can refer to the prediction reason that the server is accessed via another terminal device, and check the communication history between the terminal devices predicted to perform abnormal access in preference to other items. Setting the checking priority increases the possibility of finding abnormal access in an early stage. Similarly, when the prediction result as illustrated in FIG. 10 is presented, the administrator of the network refers to the prediction reason that the amount of data transfer is large at night, and checks the history of data transfer at night in preference to other items. This increases the possibility of finding abnormal access in an early stage.

Even in a case where abnormal access cannot be directly confirmed from the history data, the possibility of finding abnormal access is increased by enhancing monitoring of a point having a high possibility of abnormal access. By presenting the prediction reason as described above, the administrator of the network can set the checking priority among a huge amount of logs, efficiently check the item, and more reliably find the history in which abnormal access can be specified. Therefore, the abnormal access prediction system of the present example embodiment can suitably support network management such as improvement of network security and enhancement of management efficiency.

### Second Example Embodiment

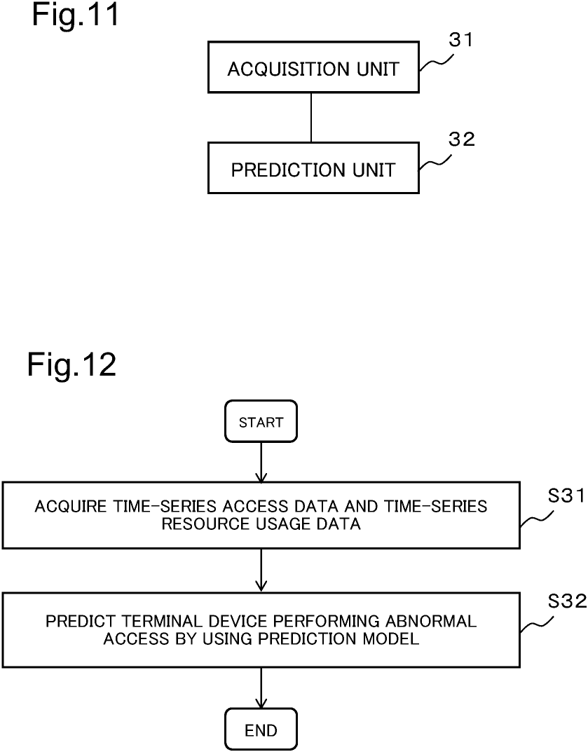

A second example embodiment of the present invention will be described in detail with reference to the drawings. FIG. 11 is a diagram illustrating a configuration outline of an abnormal access prediction system according to the present example embodiment. The abnormal access prediction system of the present example embodiment includes an acquisition unit 31 and a prediction unit 32. In a business support system of the present example embodiment, the acquisition unit 31 and the prediction unit 32 may be provided in a single device, or may be provided in different devices.

The acquisition unit 31 acquires time-series access data and time-series resource usage data in a first period. The time-series access data is data relating to access to a server on a network from a first plurality of terminal devices individually operated by a first plurality of users. The time-series resource usage data is data relating to a time-series change in resource usage of each of the first plurality of terminal devices. Specifically, the first period refers to a period in which access as a prediction target is performed when abnormal access is predicted using a prediction model. A second period is a period earlier than the first period, in which access to be used as data when generating a prediction model is performed.

The acquisition unit 31 is an example of the acquisition means. The acquisition unit 21 of the prediction device 20 in the first example embodiment is an example of the acquisition unit 31.

The prediction unit 32 predicts a terminal device that performs abnormal access among the first plurality of terminal devices by using a prediction model generated on the basis of time-series access data and time-series resource usage data in the second period earlier than the first period, and the time-series access data and the time-series resource usage data in the first period. The time-series access data in the second period is data relating to access when the server on the network is accessed from a second plurality of terminal devices individually operated by a second plurality of users in the second period. The time-series resource usage data in the second period is data relating to a time-series change in resource usage of each of the second plurality of terminal devices in the second period.

The prediction unit 32 is an example of the prediction means. The prediction unit 24 of the prediction device 20 in the first example embodiment is an example of the prediction unit 32.

An operation of the abnormality prediction system of the present example embodiment will be described. FIG. 12 is a diagram illustrating an operation flow of the abnormality prediction system according to the present example embodiment. First, the acquisition unit 31 acquires the time-series access data and the time-series resource usage data of the first plurality of terminal devices in the first period (step S31). When each data is acquired, the prediction unit 32 predicts the terminal device that performs abnormal access from the prediction model generated on the basis of the time-series access data and the time-series resource usage data in the second period, and the time-series access data and the time-series resource usage data in the first period (step S32). Specifically, the prediction unit 32 predicts whether there is a terminal device performing abnormal access among the first plurality of terminal devices by using the time-series access data and the time-series resource usage data in the first period of the first plurality of terminal devices, as abnormal access detection targets, and the prediction model.

The abnormal access prediction system of the present example embodiment predicts the terminal device that is performing abnormal access by using the prediction model, and the time-series access data and the resource usage acquired by the acquisition unit 31. The abnormal access prediction system of the present example embodiment can predict the terminal device that is performing abnormal access in consideration of access over a plurality of steps by performing the prediction using the prediction model generated using the time-series access data. Therefore, the abnormal access prediction system of the present example embodiment can improve the prediction accuracy of the terminal device that is performing abnormal access. The abnormal access prediction system of the present example embodiment can improve the prediction accuracy of the terminal device that is performing abnormal access even when the abnormal access is performed in a plurality of steps, and can suitably support network management such as improvement of network security and enhancement of management efficiency.

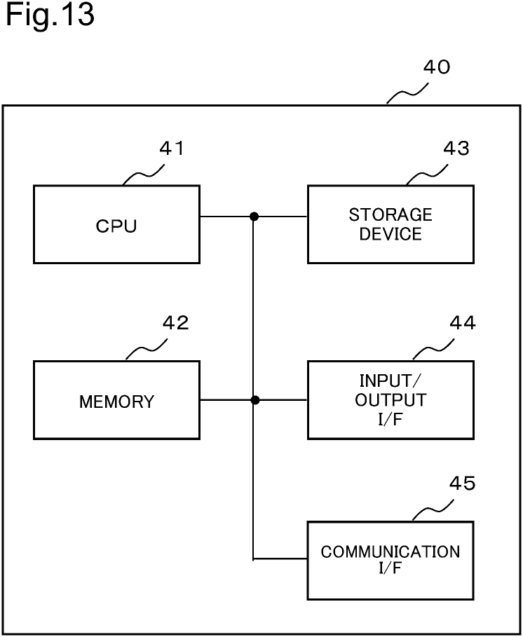

Each processing in the prediction model generation device 10 and the prediction device 20 of the first example embodiment and the acquisition unit 31 and the prediction unit 32 of the second example embodiment can be performed by executing a computer program on a computer. FIG. 13 illustrates a configuration example of a computer 40 that executes the computer program for performing each processing in the prediction model generation device 10 and the prediction device 20. The computer 40 includes a CPU 41, a memory 42, a storage device 43, an input/output interface (I/F) 44, and a communication I/F 45. The communication management server 300 of the first example embodiment can also have a similar configuration.

The CPU 41 reads the computer program for performing each processing from the storage device 43 and executes the computer program. An arithmetic processing unit that executes the computer program may be configured by a combination of a CPU and a GPU instead of the CPU 41. The memory 42 is configured by a dynamic random access memory (DRAM) or the like, and temporarily stores the computer program executed by the CPU 41 and/or data being processed. The storage device 43 stores the computer program executed by the CPU 41. The storage device 43 is configured by, for example, a nonvolatile semiconductor storage device. As the storage device 43, another storage device such as a hard disk drive may be used. The input/output I/F 44 is an interface that receives an input from an operator and outputs display data or the like. The communication I/F 45 is an interface that transmits and receives data to and from each device in the abnormal access prediction system, the terminal of the user, or the like.

The computer program used for executing each processing can also be stored in a recording medium and distributed. As the recording medium, for example, a magnetic tape for data recording or a magnetic disk such as a hard disk can be used. An optical disk such as a compact disc read only memory (CD-ROM) can also be used as the recording medium. A nonvolatile semiconductor storage device may be used as the recording medium.

Some or all of the above example embodiments may be described as, but not limited to, the following supplementary notes.

### Supplementary Note 1

An abnormal access prediction system including:
an acquisition means configured to acquire time-series access data relating to access to a server on a network from a first plurality of terminal devices individually operated by a first plurality of users, and time-series resource usage data relating to a time-series change in resource usage of each of the first plurality of terminal devices in a first period; and
a prediction means configured to predict a terminal device that performs abnormal access among the first plurality of terminal devices by using a prediction model generated based on time-series access data when the server on the network is accessed from a second plurality of terminal devices individually operated by a second plurality of users and time-series resource usage data relating to a time-series change in resource usage of each of the second plurality of terminal devices in a second period earlier than the first period, and the time-series access data and the time-series resource usage data of each of the first plurality of terminal devices in the first period.

### Supplementary Note 2

The abnormal access prediction system according to supplementary note 1, further including

a display control means configured to control a display device to display a prediction result indicating the terminal device that has possibly performed abnormal access and a reason for predicting that the abnormal access has been performed.

### Supplementary Note 3

The abnormal access prediction system according to supplementary note 2, further including
a graph generation means configured to generate graph time-series data including nodes indicating the first plurality of terminal devices and the server, and an edge indicating presence or absence of access between the nodes in the first period, in which
the display control means performs control to display the graph time-series data and the prediction result, and
the graph time-series data indicates a time-series sequence of access to the server from the first plurality of terminal devices in the first period.

### Supplementary Note 4

The abnormal access prediction system according to supplementary note 3, in which
the display control means controls the display device to display attribute data relating to an attribute of the device indicated by the node of the graph time-series data, and
the attribute data includes at least one of a type of the device, an administrator, identification information of a user who is permitted to access, a data read amount, the number of accesses from another device, a communication history, a communication amount, a connection form to the network, the number of authentications, and the number of authentication failures.

### Supplementary Note 5

The abnormal access prediction system according to any one of supplementary notes 1 to 4, further including

a prediction model generation means configured to generate the prediction model based on the time-series access data when the server on the network is accessed from the second plurality of terminal devices individually operated by the second plurality of users and the time-series resource usage data relating to the time-series change in the resource usage of each of the second plurality of terminal devices in the second period earlier than the first period.

### Supplementary Note 6

The abnormal access prediction system according to supplementary note 5, in which

the prediction model generation means performs relearning of the prediction model by using the time-series access data and the time-series resource usage data of each of the first plurality of terminal devices in the first period.

### Supplementary Note 7

An abnormal access prediction method including:
acquiring time-series access data relating to access to a server on a network from a first plurality of terminal devices individually operated by a first plurality of users, and time-series resource usage data relating to a time-series change in resource usage of each of the first plurality of terminal devices in a first period; and
predicting a terminal device that performs abnormal access among the first plurality of terminal devices by using a prediction model generated based on time-series access data when the server on the network is accessed from a second plurality of terminal devices individually operated by a second plurality of users and time-series resource usage data relating to a time-series change in resource usage of each of the second plurality of terminal devices in a second period earlier than the first period, and the time-series access data and the time-series resource usage data of each of the first plurality of terminal devices in the first period.

### Supplementary Note 8

The abnormal access prediction method according to supplementary note 7, further including:

controlling a display device to display a prediction result indicating a user who has possibly performed abnormal access and a reason for predicting that the abnormal access has been performed.

### Supplementary Note 9

The abnormal access prediction method according to supplementary note 8, further including:
generating graph time-series data, the graph time-series data including nodes indicating the first plurality of terminal devices and the server, and an edge indicating presence or absence of access between the nodes in the first period; and
controlling to display the graph time-series data and the prediction result, wherein
the graph time-series data indicates a time-series sequence of access to the server from the first plurality of terminal devices in the first period.

### Supplementary Note 10

The abnormal access prediction method according to supplementary note 9, further including:
controlling the display device to display attribute data relating to an attribute of the device indicated by the node of the graph time-series data, wherein
the attribute data includes at least one of a type of the device, an administrator, identification information of a user who is permitted to access, a data read amount, the number of accesses from another device, a communication history, a communication amount, a connection form to the network, the number of authentications, and the number of authentication failures.

### Supplementary Note 11

The abnormal access prediction method according to any one of supplementary notes 7 to 10, further including:

generating the prediction model based on the time-series access data when the server on the network is accessed from the second plurality of terminal devices individually operated by the second plurality of users and the time-series resource usage data relating to the time-series change in the resource usage of each of the second plurality of terminal devices in the second period earlier than the first period.

### Supplementary Note 12

The abnormal access prediction method according to supplementary note 11, further including:

relearning the prediction model by using the time-series access data and the time-series resource usage data of each of the first plurality of terminal devices in the first period.

### Supplementary Note 13

A program recording medium for recording an abnormal access prediction program that causes a computer to execute:
a process of acquiring time-series access data relating to access to a server on a network from a first plurality of terminal devices individually operated by a first plurality of users, and time-series resource usage data relating to a time-series change in resource usage of each of the first plurality of terminal devices in a first period; and
a process of predicting a terminal device that performs abnormal access among the first plurality of terminal devices by using a prediction model generated based on time-series access data when the server on the network is accessed from a second plurality of terminal devices individually operated by a second plurality of users and time-series resource usage data relating to a time-series change in resource usage of each of the second plurality of terminal devices in a second period earlier than the first period, and the time-series access data and the time-series resource usage data of each of the first plurality of terminal devices in the first period.

### Supplementary Note 14

An abnormal access prediction device including:
an acquisition means configured to acquire time-series access data relating to access to a server on a network from a first plurality of terminal devices individually operated by a first plurality of users, and time-series resource usage data relating to a time-series change in resource usage of each of the first plurality of terminal devices in a first period; and
a prediction means configured to predict a terminal device that performs abnormal access among the first plurality of terminal devices by using a prediction model generated based on time-series access data when the server on the network is accessed from a second plurality of terminal devices individually operated by a second plurality of users and time-series resource usage data relating to a time-series change in resource usage of each of the second plurality of terminal devices in a second period earlier than the first period, and the time-series access data and the time-series resource usage data of each of the first plurality of terminal devices in the first period.

The present invention has been particularly shown and described using the above-described example embodiments as exemplary embodiments. However, the present invention is not limited to these example embodiments. It will be understood by those of ordinary skill in the art that various modes may be employed without departing from the sprit and scope of the present invention as defined by the claims.

### Reference Signs List

10 prediction model generation device
11 acquisition unit
12 storage unit
13 graph generation unit
14 prediction model generation unit
15 prediction model storage unit
16 prediction model output unit
20 prediction device
21 acquisition unit
22 prediction model storage unit
23 graph generation unit
24 prediction unit
25 prediction reason generation unit
26 display control unit
31 acquisition unit
32 prediction unit
40 computer
41 CPU
42 memory
43 storage device
44 input/output I/F
45 communication I/F
100 prediction system
300 communication management server

What is claimed is:

1. An abnormal access prediction system comprising:
at least one memory storing instructions; and
at least one processor configured to access the at least one memory and execute the instructions to:
acquire time-series access data relating to access to a server on a network from a first plurality of terminal devices individually operated by a first plurality of users, and time-series resource usage data relating to a time-series change in resource usage of each of the first plurality of terminal devices in a first period; and
predict a terminal device that performs abnormal access among the first plurality of terminal devices based on the time-series access data and the time-series resource usage data of each of the first plurality of terminal devices in the first period by using a prediction model, wherein
the prediction model is generated based on time-series access data relating to an access to the server on the network from a second plurality of terminal devices individually operated by a second plurality of users and time-series resource usage data relating to a time-series change in resource usage of each of the second plurality of terminal devices in a second period earlier than the first period.

2. The abnormal access prediction system according to claim 1, wherein
the at least one processor is further configured to execute the instructions to:
display a prediction result indicating the terminal device that has possibly performed abnormal access and a reason for predicting that the abnormal access has been performed.

3. The abnormal access prediction system according to claim 2, wherein
the at least one processor is further configured to execute the instructions to:
generate graph time-series data including nodes indicating the first plurality of terminal devices and the server, and an edge indicating presence or absence of access between the nodes in the first period; and
display the graph time-series data and the prediction result, wherein
the graph time-series data indicates a time-series sequence of access to the server from the first plurality of terminal devices in the first period.

4. The abnormal access prediction system according to claim 3, wherein the at least one processor is further configured to execute the instructions to:
display attribute data relating to an attribute of the device indicated by the node of the graph time-series data, wherein
the attribute data includes at least one of a type of the device, an administrator, identification information of a user who is permitted to access, a data read amount, the number of accesses from another device, a communication history, a communication amount, a connection form to the network, the number of authentications, and the number of authentication failures.

5. The abnormal access prediction system according to claim 1, wherein
the at least one processor is further configured to execute the instructions to:
generate the prediction model based on the time-series access data relating to an access to the server on the network from the second plurality of terminal devices individually operated by the second plurality of users and the time-series resource usage data relating to the time-series change in the resource usage of each of the second plurality of terminal devices in the second period earlier than the first period.

6. The abnormal access prediction system according to claim 5, wherein the at least one processor is further configured to execute the instructions to:
perform relearning of the prediction model by using the time-series access data and the time-series resource usage data of each of the first plurality of terminal devices in the first period.

7. An abnormal access prediction method comprising:
acquiring time-series access data relating to access to a server on a network from a first plurality of terminal devices individually operated by a first plurality of users, and time-series resource usage data relating to a time-series change in resource usage of each of the first plurality of terminal devices in a first period; and
predicting a terminal device that performs abnormal access among the first plurality of terminal devices based on the time-series access data and the time-series resource usage data of each of the first plurality of terminal devices in the first period by using a prediction model, wherein
the prediction model is generated based on time-series access data relating to an access to the server on the network is accessed from a second plurality of terminal devices individually operated by a second plurality of users and time-series resource usage data relating to a time-series change in resource usage of each of the second plurality of terminal devices in a second period earlier than the first period.

8. The abnormal access prediction method according to claim 7, further comprising:
displaying a prediction result indicating a user who has possibly performed abnormal access and a reason for predicting that the abnormal access has been performed.

9. The abnormal access prediction method according to claim 8, further comprising:
generating graph time-series data, the graph time-series data including nodes indicating the first plurality of terminal devices and the server, and an edge indicating presence or absence of access between the nodes in the first period; and
displaying the graph time-series data and the prediction result, wherein
the graph time-series data indicates a time-series sequence of access to the server from the first plurality of terminal devices in the first period.

10. The abnormal access prediction method according to claim 9, further comprising:
displaying attribute data relating to an attribute of the device indicated by the node of the graph time-series data, wherein
the attribute data includes at least one of a type of the device, an administrator, identification information of a user who is permitted to access, a data read amount, the number of accesses from another device, a communication history, a communication amount, a connection form to the network, the number of authentications, and the number of authentication failures.

11. The abnormal access prediction method according to claim 7, further comprising:
generating the prediction model based on the time-series access data relating to an access to the server on the network from the second plurality of terminal devices individually operated by the second plurality of users and the time-series resource usage data relating to the time-series change in the resource usage of each of the second plurality of terminal devices in the second period earlier than the first period.

12. The abnormal access prediction method according to claim 11, further comprising:
relearning the prediction model by using the time-series access data and the time-series resource usage data of each of the first plurality of terminal devices in the first period.

13. A non-transitory program recording medium for recording an abnormal access prediction program that causes a computer to execute:
a process of acquiring time-series access data relating to access to a server on a network from a first plurality of terminal devices individually operated by a first plurality of users, and time-series resource usage data relating to a time-series change in resource usage of each of the first plurality of terminal devices in a first period; and
a process of predicting a terminal device that performs abnormal access among the first plurality of terminal devices based on the time-series access data and the time-series resource usage data of each of the first plurality of terminal devices in the first period by using a prediction model, wherein
the prediction model is generated based on time-series access data relating to an access to the server on the network from a second plurality of terminal devices individually operated by a second plurality of users and time-series resource usage data relating to a time-series change in resource usage of each of the second plurality of terminal devices in a second period earlier than the first period.
